(19) United States
(12) Patent Application Publication
(10) Pub. No.: US 2006/0114594 A1
(43) Pub. Date: Jun. 1, 2006

(54) Electronic device comprising recording and reproducing unit

(75) Inventor: Kazunori Kunimoto, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/269,692

(22) Filed: Nov. 9, 2005

(30) Foreign Application Priority Data
Nov. 30, 2004 (JP) 2004-346487
Mar. 29, 2005 (JP) 2005-094316

(51) Int. Cl. G11B 15/46

(52) U.S. Cl. 360/73.03

(57) ABSTRACT

An electronic device capable of removably mounting a recording and reproducing unit such as a hard disk drive and the like is provided, while giving consideration to sound proofing measures in the device.

A structure is provided such that: an opening portion 7 is formed at a bottom face side of a chassis 4; a bottom plate 3 which covers the opening portion 7 is mounted on a hard disk unit 8 in which a hard disk drive 10 and a control board 11 are integrated with each other; and the hard disk unit 8 is mounted on or removed from the opening portion 7; and a shield member 6 and/or a sound proof member for covering the hard disk unit 8 are/is mounted on a top face side of the opening portion 7.

### BACKGROUND OF THE INVENTION

1. Field of the Invention

The present invention relates to an electronic device comprising a recording and reproducing unit. More particularly, the present invention relates to an electronic device which enables removable mounting of a recording and reproducing unit such as a hard disk drive.

2. Description of the Related Art

An electronic device incorporating a hard disk drive as a recording and reproducing unit has been practically widely utilized for both of business use or home use. As a result, while a larger capacity or a higher density of a hard disk is accelerated, the product service life of the hard disk drive is reduced more remarkably. In particular, in recent years, there has been a tendency of reducing the guarantee period of the hard disk drive as a part of a measure for cost reduction on the manufacturer side. Thus, there is a possibility of a worker involved in maintenance or repair frequently carrying out replacement or repair of a hard disk drive.

In such a circumstance, there has been a great problem that a work of replacing a hard disk drive can be easily carried out by a user oneself as well as the manufacturer's worker.

In addition, there is another problem as to how to restrict noise generated by driving a hard disk drive in order to maintain a good viewing environment in enjoying cinema viewing or music appreciation by using an electronic device for home use.

In Japanese Patent Application Laid-open No. 2002-238008, in order to solve the above described problems, there is disclosed a structure of providing a housing section at the front lower part in an image receiver housing, installing a tray which enables forward, slidable retraction into the housing section, and mounting a hard disk drive on the tray, in a television image receiver incorporating the hard disk drive. With this structure, it becomes possible to forwardly slidably retract the mounted tray of the hard disk drive from the front face of the television image receiver at the time of replacement of the hard disk drive, and to easily replace the hard disk drive.

Further, in Japanese Patent Application Laid-open No. 2002-008361, there is disclosed, as a first structure, a structure of installing a hard disk drive between two circuit boards vertically fixed on a chassis, the structure being compatible with a function as a sound proof material on the two circuit boards, in an electronic device such as a video recording and reproducing unit incorporating the hard disk drive. Further, in Japanese Patent Application Laid-open No. 2002-008361, there is disclosed, as a second structure, a structure of providing an opening portion on a housing top of the electronic device in order to achieve simplification and noise proofing measures in mounting and removing the hard disk drive at the same time, making it possible to removably mount the hard disk drive on the opening portion, and attached sound proof materials onto a cap plate back face for covering the opening portion and a front panel interior face side of a device main body as a noise shielding measure.

A hard disk drive can be easily mounted or removed by using the above described technique. However, in the structure of Japanese Patent Application Laid-open No. 2002-238008, it is easily predicted that noise caused by driving of the hard disk drive leaks from a front face of a television image receiver because a top part of a slide type tray housing the hard disk drive is kept open. Thus, there is a failure that a problem of providing a viewing environment good for a user is left unsolved.

In a second structure of Japanese Patent Application Laid-open No. 2002-008361, a hard disk drive can be mounted or removed very easily, and a noise shielding measure is taken by attaching sound proof materials to their required portions. However, a gap is provided between a buffer material provided on a front panel interior face for attaching a sound proof material and a buffer material provided on a back face of a cap plate. Thus, there is a danger that the noise generated at the time of driving the hard disk drive leaks from the gap. In addition, because of a structure in which an opening portion is provided on a top of an electronic device, there is a danger that a little child mistakenly opens the opening portion and an electrical shock occurs due to touching electronic parts disposed in the device. In addition, because of a structure in which an opening portion is fixed to a top by means of screws, a design of an appearance of the electronic device is degraded. Further, there is apprehension that a foreign object such as water or dust enters the inside of the electronic device through the opening portion.

In a first structure of Japanese Patent Application Laid-open No. 2002-008361, although the noise generated due to driving of the hard disk drive can be prevented to a certain degree, there is provided a structure in which two circuit boards compatible with a sound proof material are disposed so as to sandwich the hard disk drive. Thus, in carrying out replacement and repair of the hard disk drive, there is a need for sequentially removing electronic parts including the circuit boards disposed inside of the electronic device and reassembling the removed electronic parts in the electronic device after the hard disk drive has been replaced. Therefore, there is a failure that a work of mounting or removing the hard disk drive becomes complicated.

### SUMMARY OF THE INVENTION

In order to solve the foregoing problem, the present invention provides an electronic device comprising, in a housing: a recording and reproducing unit; and a control board which controls the recording and reproducing unit, wherein a structure capable of removably mounting the recording and reproducing unit from a bottom face side of the housing is provided. Further, the present invention, provides an electronic device comprising, in a housing: a recording and reproducing unit; and a control board which controls the recording and reproducing unit, wherein a structure capable of removably mounting the recording and reproducing unit from a rear face side of the housing is provided.

Further, the present invention provides the electronic device comprising the recording and reproducing unit according to the above-described electronic device comprising the recording and reproducing unit, wherein an opening portion of a size according to external dimensions in a direction in which the recording and reproducing unit is removably mounted is formed on a housing face in a direction in which the recording and reproducing unit of the housing can be removably mounted.

In addition, in the above-described electronic device comprising the recording and reproducing unit, the present invention provides the electronic device comprising the recording and reproducing unit, wherein the opening portion is continuously formed on a bottom face side and a rear face side of a housing, and further, the present invention provides the electronic device comprising the recording and reproducing unit, further comprising a cover member having a size for covering the opening portion, wherein the recording and reproducing unit is mounted on the cover member, and the recording and reproducing unit is configured to be removable from the housing together with the cover member. Further, the present invention provides the electronic device comprising the recording and reproducing unit, wherein the cover member is either one of a cover member having a size for covering the opening portion formed on the bottom face of the housing, a cover member having a size for covering the opening portion formed on the rear face of the housing, and a cover member having a size for covering the opening portion continuously formed on the bottom face and the rear face of the housing.

Further, the present invention provides the electronic device comprising the recording and reproducing unit, wherein the cover member having the size for covering the opening portion continuously formed on the bottom face and the rear face of the housing is integrally formed. Further, in the above-described electronic device comprising the recording and reproducing unit, the present invention provides the electronic device comprising the recording and reproducing unit, wherein the cover member having the size for covering the opening portion continuously formed on the bottom face and the rear face of the housing has different members between a member covering a bottom face portion and a member covering a rear face portion.

Further, the present invention provides the electronic device comprising, in a housing, a recording and reproducing unit and a control board which controls the recording and reproducing unit, wherein the recording and reproducing unit is constituted to be mountable and removable from a bottom face side or a rear face side of the housing and comprises a sound proof member or a shield member for covering the opening portion.

In addition, in the above-described electronic device comprising the recording and reproducing unit, the present invention provides the electronic device comprising the recording and reproducing unit, wherein a main board which controls the electronic device is disposed in a housing of the electronic device; and wherein a connector terminal provided on the main board and a connector terminal provided on the recording and reproducing unit or a control board which controls the recording and reproducing unit are proximal to each other in the housing.

Further, in the above-described electronic device comprising the recording and reproducing unit, the present invention provides an electronic device comprising the recording and reproducing unit, wherein the connector terminal provided on the main board and the connector terminal provided on the recording and reproducing unit or the control board which controls the recording and reproducing unit are linked with each other via a wire rod.

Further, in the above-described electronic device comprising the recording and reproducing unit, the present invention provides the electronic device comprising the recording and reproducing unit, wherein the recording and reproducing unit is a hard disk drive configured by assembling a recording medium in the unit in advance.

According to the present invention, it becomes possible to easily mount or remove a hard disk drive with respect to a bottom face side and/or a rear face side of an electronic device. By providing a structure capable of mounting and removing the hard disk unit with respect to the bottom face side and/or rear face side of the electronic device, a work of sequentially disassembling the top or front panel serving as a decorative member of the device, a shield member or a sound proof member and the like mounted in the device in accordance with predetermined work procedures is eliminated, thus making it possible to very easily carry out fault finding of the hard disk drive or a mounting and removing work at the time of replacement. In addition, a hard disk unit is mounted in the electronic device so that a connector terminal provided on a board disposed inside of the electronic device and a connector terminal provided on a hard disk drive or a control board for controlling the hard disk drive are disposed proximal to each other. In this manner, the work of mounting and removing the hard disk unit can be carried out smoothly without cables for connecting their respective connector terminals being twisted in the electronic device. Further, the length of cables for connecting their respective connector terminals can be restricted to the minimum, thereby making it possible to ensure cost reduction of wiring member. In addition, a hard disk drive provided as a unit is structured to be mountable on and removable from the bottom face side and/or the rear face side of the device, thereby making it possible to dispose the shield member or sound proof member which covers the periphery of the hard disk drive without considering removal of the hard disk drive. Thus, countermeasures against unwanted irradiation and noise relevant to the hard disk drive can be reliably taken.

In addition, in the step of assembling the electronic device according to the present invention, parts are assembled in advance excluding a hard disk unit and a cover member mounted on the bottom face side and/or the rear face side of the housing. It is possible to define a work process for mounting the hard disk unit from the bottom face side and/or rear face side of the housing in a final step, the hard disk unit having the cover member mounted on the bottom face side and/or rear face side. That is, a hard disk unit weak to vibration or shock can be assembled in the step at a final stage, thus making it possible to reduce a failure rate caused by damage of the hard disk drive in the assembling work process. In addition, by defining the step of assembling the hard disk drive at a final stage, a worker who carries out an assembling work at an initial stage is never sensitive to vibration or shock, thus achieving improvement of a whole assembling work speed. Further, a structure of assembling a hard disk unit from the rear face side of a housing which configures an appearance of the electronic device is provided, thereby making it possible to easily assemble the hard disk unit in a posture in a normal use state of the electronic device configured by assembling in advance a member other than the hard disk unit. Thus, when assembling the hard disk unit, the worker can easily carry out assembling without carrying out a redundant work such as changing the orientation of the electronic device.

In addition, according to the present invention, there is provided a structure of carrying out hard disk drive replacement from the bottom face side and/or rear face side of the electronic device. Thus, in a normal use state, the user cannot see a portion at which the hard disk unit is to be mounted, from the front face side of the electronic device where the user makes a visual check. Therefore, a design of an appearance of the device is not degraded. Further, an unpredicted circumstance such as mistaken opening by a little child or entry of a foreign object such as water or dust into the electronic device through its opening portion can be prevented.

### BRIEF DESCRIPTION OF THE DRAWINGS

FIG. 1 is a perspective view showing a top side of an electronic device illustrating an embodiment of the present invention;

FIG. 2 is a perspective view showing a bottom face side of an electronic device illustrating a first embodiment of the present invention;

FIG. 3 is an exploded perspective view of the electronic device illustrating the first embodiment of the present invention;

FIG. 4 is an exploded perspective view of a hard disk unit illustrating the first embodiment of the present invention;

FIG. 5 is a perspective view showing a state before a bottom plate is mounted at a lower part of the hard disk unit illustrating the first embodiment of the present invention;

FIG. 6 is a perspective view showing a state after the bottom plate has been mounted at the lower part of the hard disk unit illustrating the first embodiment of the present invention;

FIG. 7 is a front view showing the hard disk unit including the bottom plate illustrating the first embodiment of the present invention;

FIG. 8 is a plan view showing the hard disk unit including the bottom plate illustrating the first embodiment of the present invention;

FIG. 9 is a side view showing the hard disk unit including the bottom plate illustrating the first embodiment of the present invention;

FIG. 10 is a side cross section of an electronic device showing a mounted state of the hard disk unit illustrating the first embodiment of the present invention;

FIG. 11 is a side cross section of an electronic device showing a removed state of the hard disk unit illustrating the first embodiment of the present invention;

FIG. 12 is a perspective view showing a rear face side of an electronic device illustrating a second embodiment of the present invention;

FIG. 13 is an exploded perspective view of the electronic device illustrating the second embodiment of the present invention;

FIG. 14 is an exploded perspective view of a hard disk unit illustrating the second embodiment of the present invention;

FIG. 15 is a perspective view showing a state before a rear plate is mounted at a rear part of the hard disk unit illustrating the second embodiment of the present invention;

FIG. 16 is a perspective view showing a state after the rear plate has been mounted at the rear part of the hard disk unit illustrating the second embodiment of the present invention;

FIG. 17 is a perspective view showing a state in which the hard disk unit has been mounted on a chassis illustrating the second embodiment of the present invention;

FIG. 18 is a side cross section of an electronic device showing a mounted state of the hard disk unit illustrating the second embodiment of the present invention; and

FIG. 19 is a side cross section of an electronic device showing a removed state of the hard disk unit illustrating the second embodiment of the present invention.

### DESCRIPTION OF THE PREFERRED EMBODIMENTS

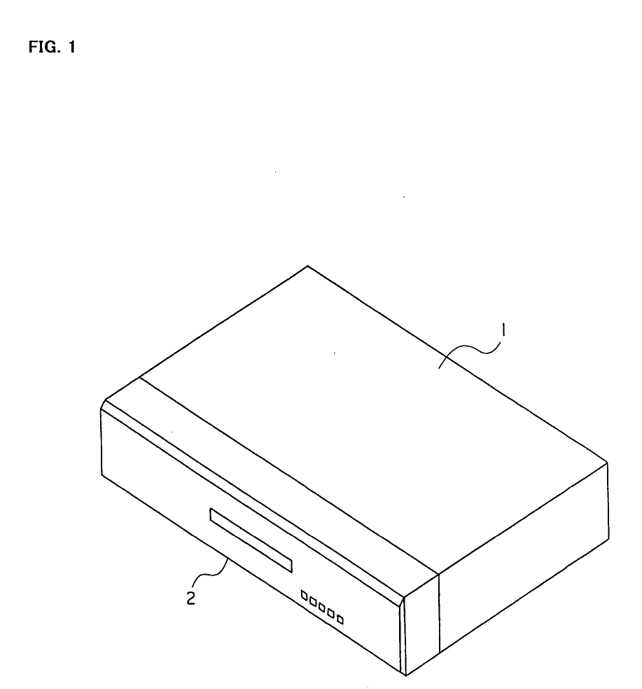

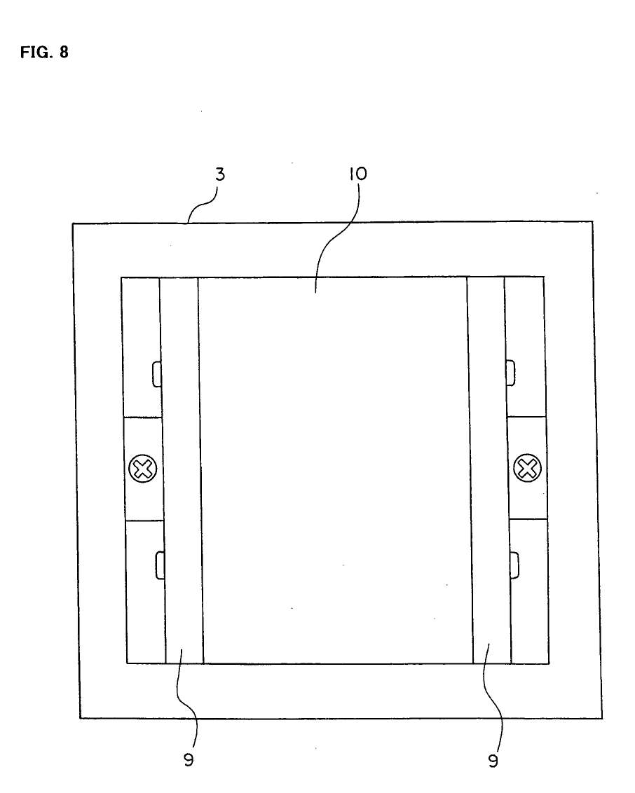

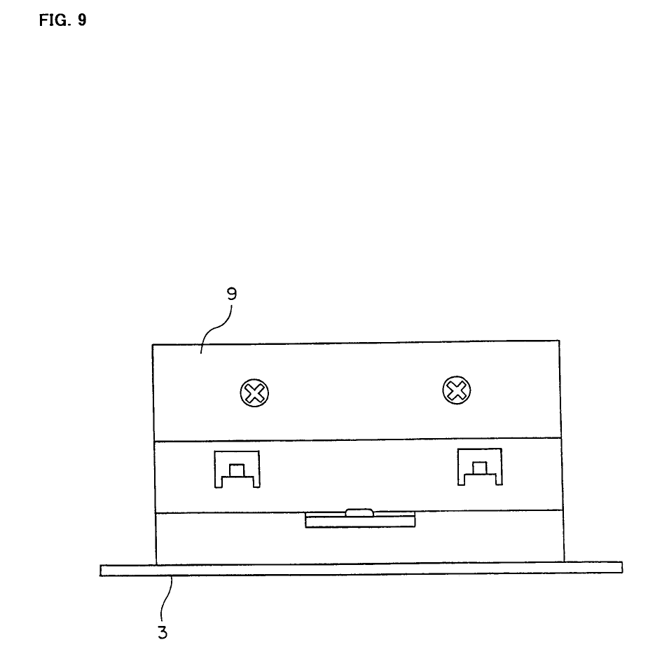

Hereinafter, as a best mode for carrying out the invention, embodiments of the present invention will be described with reference to FIGS. 1 to 19. FIG. 1 is a perspective view showing a top face side in a stationary electronic device incorporating a hard disk drive according to an embodiment of the present invention, wherein reference numeral 1 denotes a top plate of the electronic device; and reference numeral 2 denotes a front panel including an operating section of the electronic device. Here, the operating face side of the electronic device is defined as a front face side, and a side opposed to the front face side is defined as a rear face side. In addition, in an installation state in which the electronic device is generally used, the top plate side of the electronic device is defined as a top face side, and a side opposed to the top plate side is defined as a bottom face side. Embodiments of the present invention will be described below in detail. In the present embodiment, although a stationary electronic device incorporating a hard disk drive will be described as an example, the present invention can be easily applied to a construction other than those described in the embodiments without departing from the spirit of the invention.

### First Embodiment

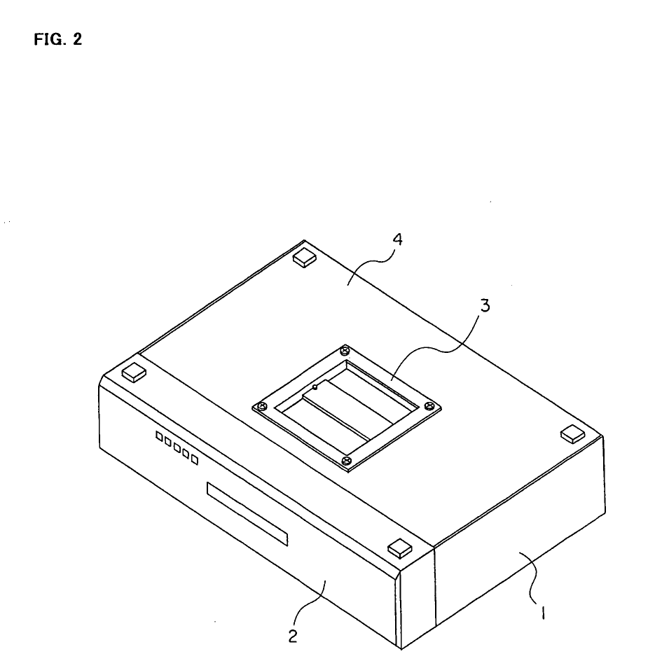

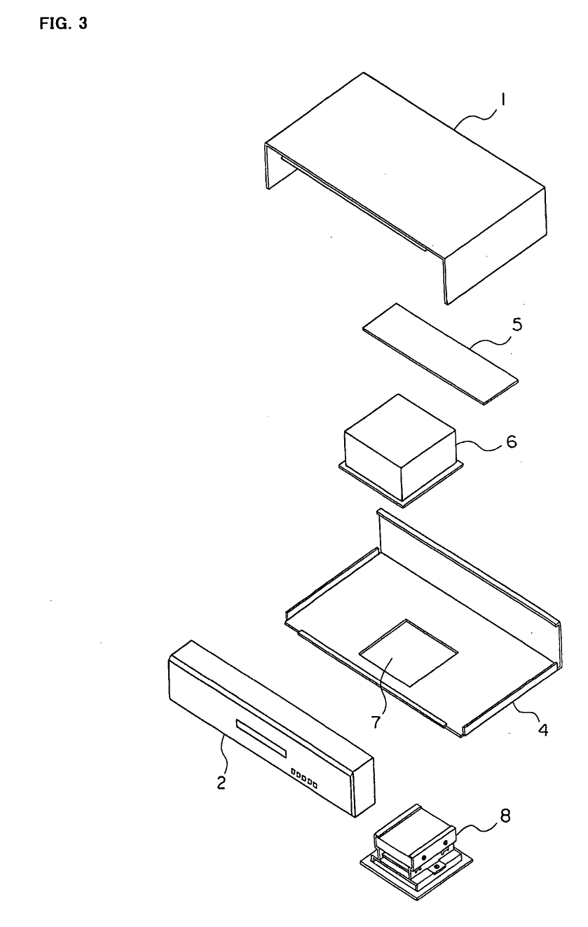

A first embodiment of the present invention will be described with reference to FIGS. 2 to 11. FIG. 2 is a perspective view showing a state in which an electronic device is viewed from its bottom face side, wherein an opening portion 7 described later is formed at the bottom face side of a chassis 4 which forms a bottom face of the electronic device, and the opening portion 7 is covered with a cover member 3 (hereinafter, this cover member is referred to as a bottom plate). FIG. 3 is an exploded perspective view showing main constituent elements in the electronic device, wherein a housing of the electronic device is configured by combining a top plate 1, a front panel 2, and the chassis 4. The opening portion 7 described previously is formed at the bottom face side of the chassis 4, and the opening portion 7 is formed in dimensions such that a hard disk unit 8 described later can be mounted on or removed from the inside of the housing. In addition, a shield member 6 and/or a sound proof member integrally formed so as to surround the periphery of the hard disk unit 8 described later are/is mounted at the top face side of the opening portion 7 formed at the bottom face side of the chassis 4.

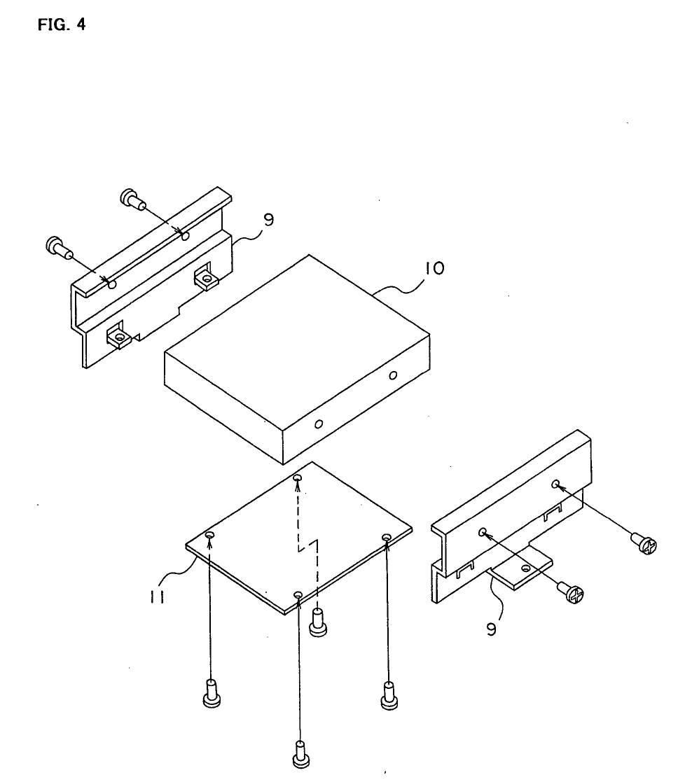

FIG. 4 is an exploded perspective view showing a state before assembling the hard disk unit 8. A pair of support members 9 are mounted at both sides of a hard disk drive 10; a control board 11 for controlling the hard disk drive 10 is mounted on the support members 9, and the hard disk drive 10, the control board 11, and the support members 9 are integrally provided as a unit. Hereinafter, a description will be continued while this unit is referred to as the hard disk unit 8.

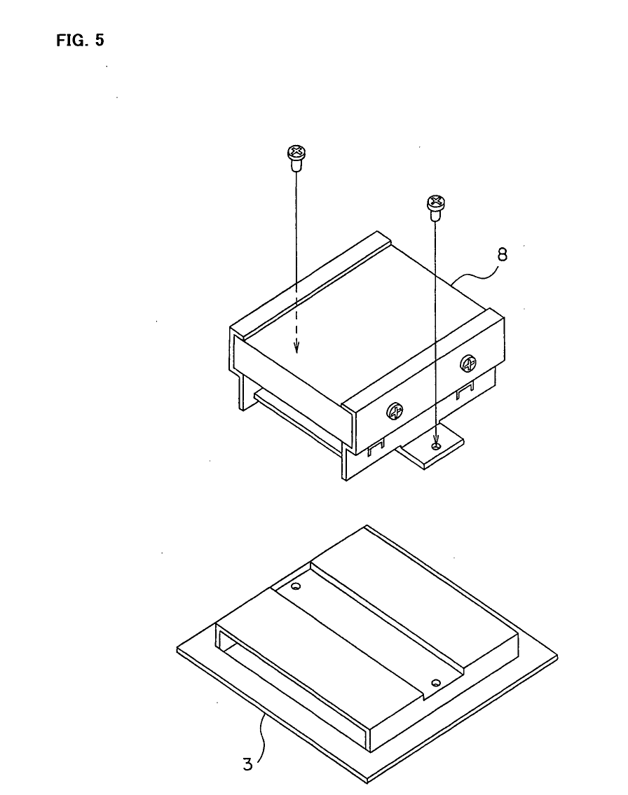

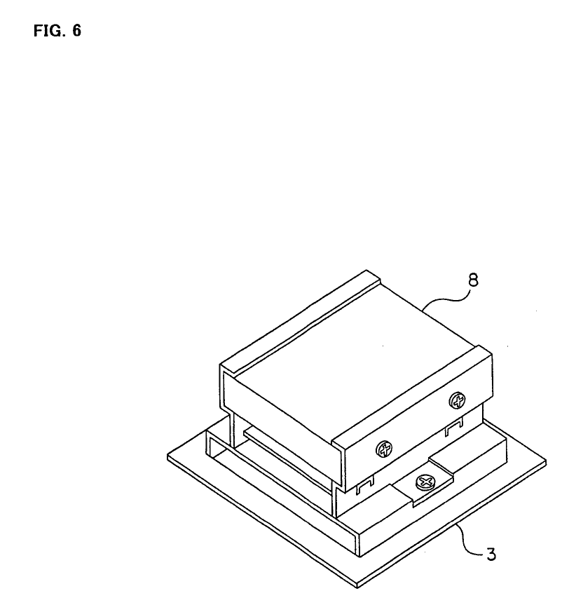

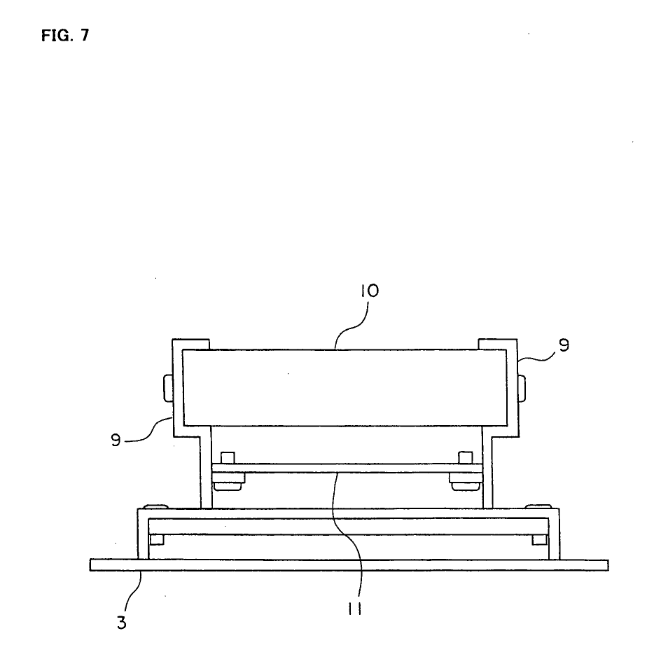

FIG. 5 is a perspective view showing a state before mounting the bottom plate 3 at the bottom face side of the hard disk unit 8, and FIG. 6 is a perspective view showing a state after mounting the bottom face 3 at the bottom face side of the hard disk unit 8. In addition, FIGS. 7 to 9 are a front view, a plan view, and a side view each showing the hard disk unit 8 having the bottom plate 3 mounted thereon. When the bottom plate 3 is mounted on the bottom face side of the hard disk unit 8, a member having a shield effect and/or a sound proof effect is mounted together with the bottom plate 3 or the bottom plate 3 itself is formed of a member having the shield effect and/or the sound proof effect, whereby the bottom plate may be mounted on the hard disk unit 8.

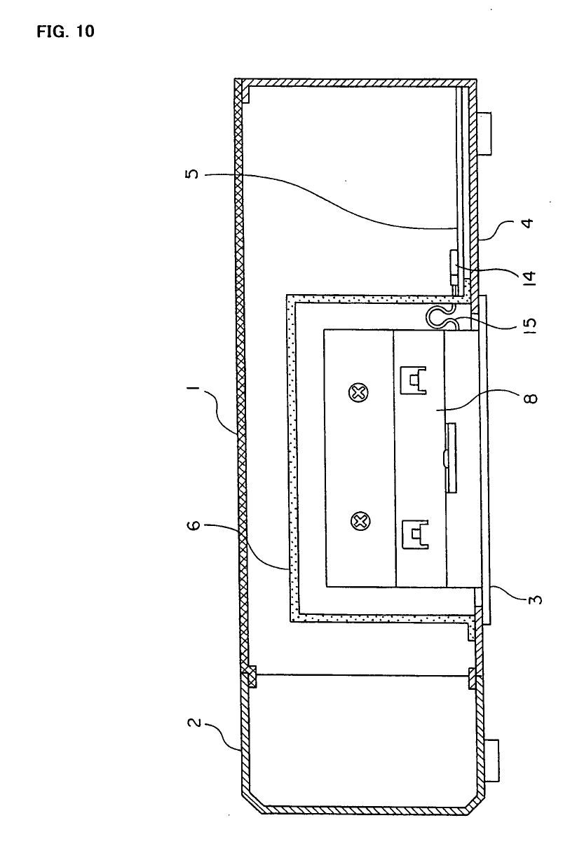

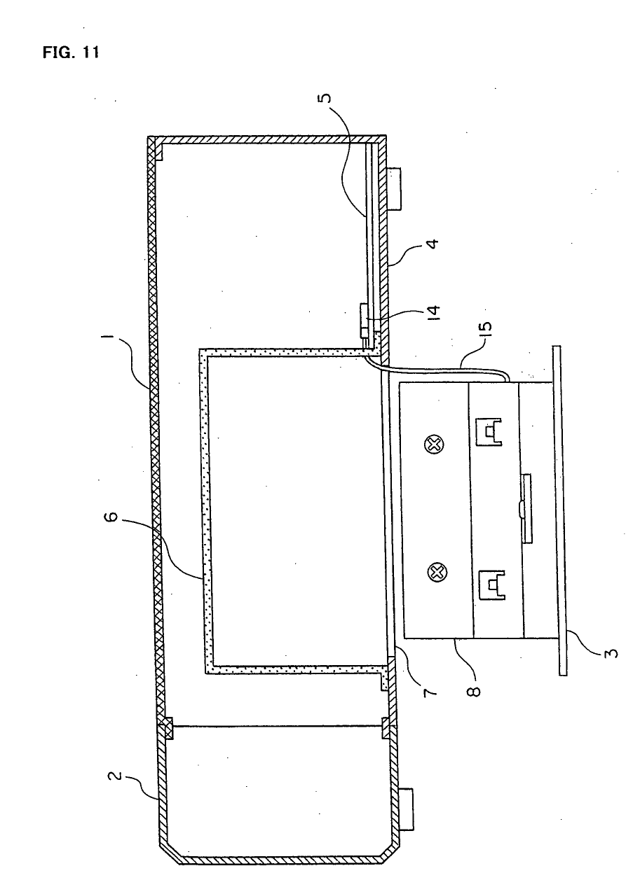

FIG. 10 is a side cross section of the electronic device showing a state in which the hard disk unit 8 is mounted in the electronic device. In the figure, a connector terminal 14 provided on a main board 5 for controlling the electronic device disposed inside of the electronic device, and a connector terminal (not shown) provided on a control board 11 of the hard disk unit 8, are connected to each other via a cable 15. The hard disk unit 8 is mounted from the outside of the electronic device so that the connector terminal 14 provided on the main board 5 in the electronic device and the connector terminal (not shown) provided on the control board 11 of the hard disk unit 8 are proximal to each other. In addition, in the case where hard disk control is included in the main board 5, a connector terminal (not shown) provided in the hard disk drive 10 and the connector terminal 14 provided on the main board 5 are disposed to be proximal to each other, and the connector terminal (not shown) provided in the hard disk drive 10 and the connector terminal 14 provided on the main board 5 are connected to each other via the cable 15. While the present embodiment has described a case in which the connector terminal 14 provided on the main board 5 in the electronic device and the connector terminal (not shown) at the side of the hard disk drive 10 are connected to each other via the cable 15, means for directly connecting two connector terminals opposed to each other, for example, may be used without being limited thereto. FIG. 11 is a side cross section of the electronic device showing a state in which the hard disk unit 8 has been removed from the electronic device.

Now, an internal structure of an electronic device in the present embodiment will be described here. As shown in FIG. 3, the shield member 6 is mounted so as to cover the top face side of the opening portion 7 formed on the chassis 4. An inside space of the shield member 6 and an outside space of the shield member 6 are formed in a housing, and the inside space of the shield member 6 is defined as a housing space of the hard disk unit 8. The opening portion 7 formed at the bottom face side of the chassis 4 is formed in dimensions such that the hard disk unit 8 can be mounted on or removed from the inside of the housing. In addition, the outside space of the shield member 6 is provided as a space for arranging constituent elements of the electronic device excluding the hard disk unit 8, and the main board 5 is also one of the constituent elements.

On the other hand, as shown in FIGS. 5 to 9, the bottom plate 3 is assembled at the bottom face side of the hard disk unit 8, and the hard disk unit 8 including the bottom plate 3 is assembled from the bottom face side of the electronic device into an inside space of the electronic device through the opening portion 7 of the chassis 4, whereby the bottom plate 3 functions as a cover member which covers the opening portion 7 formed on the chassis 4 of the electronic device. Fixing means used when the bottom plate 3 is assembled at the bottom face side of the chassis 4 is not limited in particular, and a variety of removable fixing means such as screw tightening or a hook having a claw section can be used.

Now, a description will be given with respect to specific procedures when a user replaces the hard disk drive 10 assembled in the electronic device. First, as shown in FIG. 10, the top face side and the bottom face side of the electronic device are inverted in a state in which the hard disk unit 8 is mounted in the device, and the bottom face side of the electronic device is placed to be its top face side, as shown in FIG. 2. Further, fixing means such as a screw or a hook for assembling the bottom plate 3 on the chassis 4 is removed, assembling between the bottom plate 3 and the chassis 4 is removed, and the bottom plate 3 is removed from the electronic device, whereby, as shown in FIG. 11, the bottom plate 3 and the hard disk unit 8 can be removed from the opening portion 7 to the outside of the housing of the electronic device in their integrated state. A tightening tool such as a screw is removed from the hard disk unit 8 removed from the housing of the electronic device, and the current hard disk drive is replaced with a new hard disk drive 10. In the case where the new hard disk drive 10 after replaced is mounted on the electronic device, this mounting can be easily achieved by reversing the above procedures. In addition, when the hard disk drive 10 is removed from the hard disk unit 8, the support members 9 and the control board 11 assembled together with he hard disk drive 10 are fully removed, whereby the support members 9 and the control board 11 may be assembled with the new hard disk drive 10 to replace. However, in the case of the present embodiment, a construction in which the hard disk drive 10 and the control board 11 are assembled with the support members 9 is provided, and thus, a tightening tool for tightening the hard disk drive 10 and the support members 9 is removed, thereby making it possible to remove and replace only the hard disk drive 10 from the hard disk unit 8. Further, only the hard disk drive 10 can be removed and replaced in a state in which the bottom plate 3 is assembled with the hard disk unit 8.

### Second Embodiment

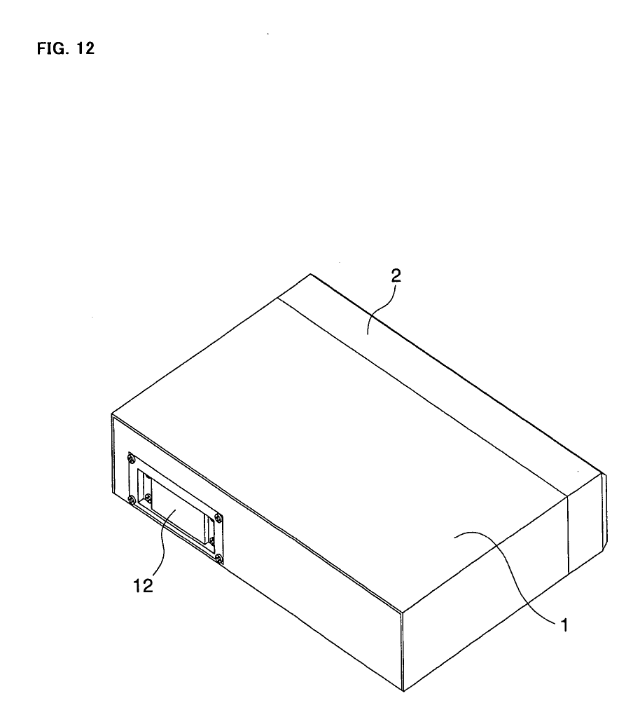

Now, a second embodiment of the present invention will be described with reference to FIGS. 12 to 19. While the first embodiment has described a structure capable of mounting and removing the hard disk unit 8 including the hard disk drive 10 on or from the bottom face side of the electronic device, the present embodiment will describe a structure capable of mounting or removing a hard disk unit 8 including a hard disk drive 10 on or from a rear face side of an electronic device.

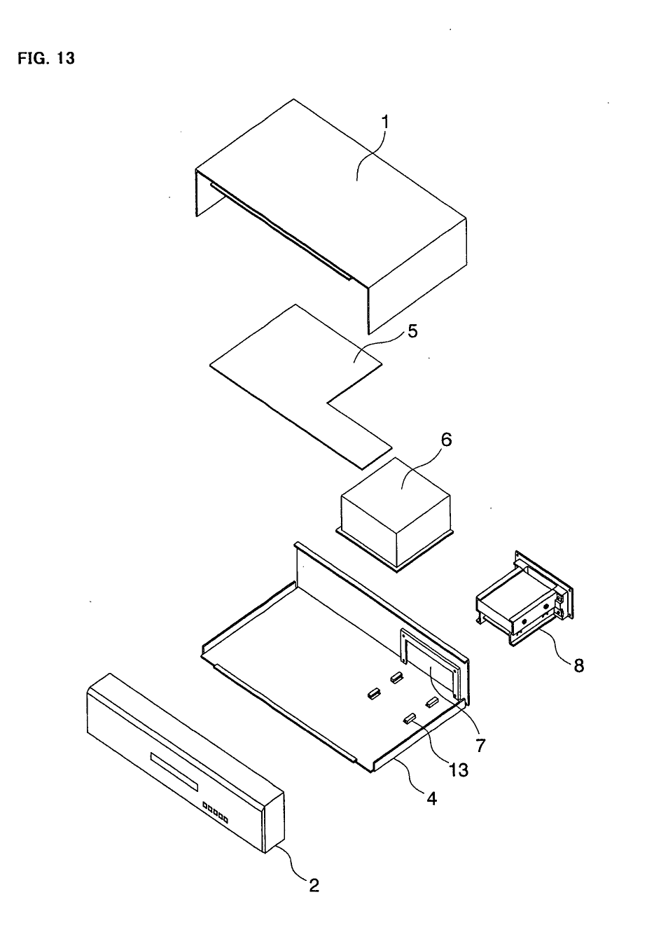

FIG. 12 is a perspective view showing a state in which the electronic device is viewed from its rear face side, wherein an opening portion 7 described later is formed at the rear face side of a chassis 4 which forms a bottom face and a rear face of the electronic device, and the opening portion 7 is covered with a cover member 12 (hereinafter, this cover member is referred to as a rear plate). FIG. 13 is an exploded perspective view showing main constituent elements in the electronic device, wherein a housing of the electronic device is configured by combining a top plate 1, a front panel 2, and the chassis 4. The opening portion 7 described previously is formed at the rear face side of the chassis 4, and further, a guide member 13 which guides and holds the hard disk unit 8 described later inserted from the outside of the electronic device via the opening portion 7 at its mounting position is formed integrally with the chassis 4 by means of lancing. The opening portion 7 is formed in dimensions such that the hard disk unit 8 described later can be mounted on or removed from the inside of the housing, and a shield member 6 and/or a sound proof member integrally formed so as to surround the periphery of the hard disk unit 8 described later are/is mounted at the front face side of the opening portion 7 formed at the rear face side of the chassis 4.

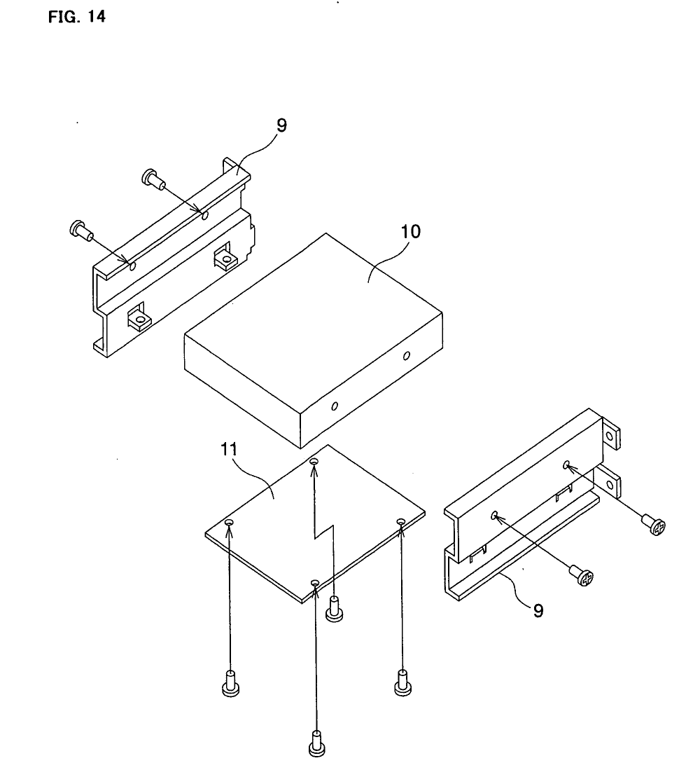

FIG. 14 is an exploded perspective view showing a state before assembling the hard disk unit 8. A pair of support members 9 are mounted at both sides of the hard disk drive 10; a control board 11 for controlling the hard disk drive 10 is mounted on the support members 9; and the hard disk drive 10, the control board 11, and the support members 9 are integrally provided as a unit. Hereinafter, a description will be continued while this unit is referred to as the hard disk unit 8.

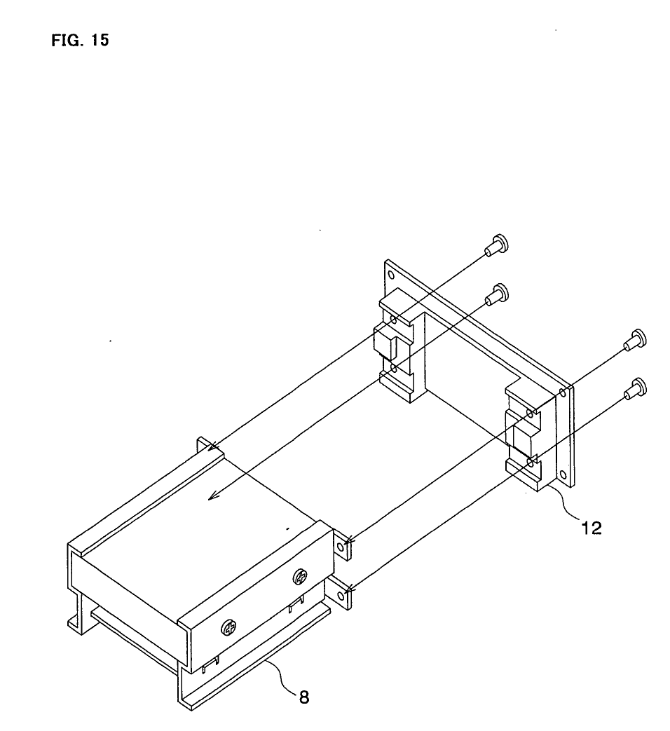

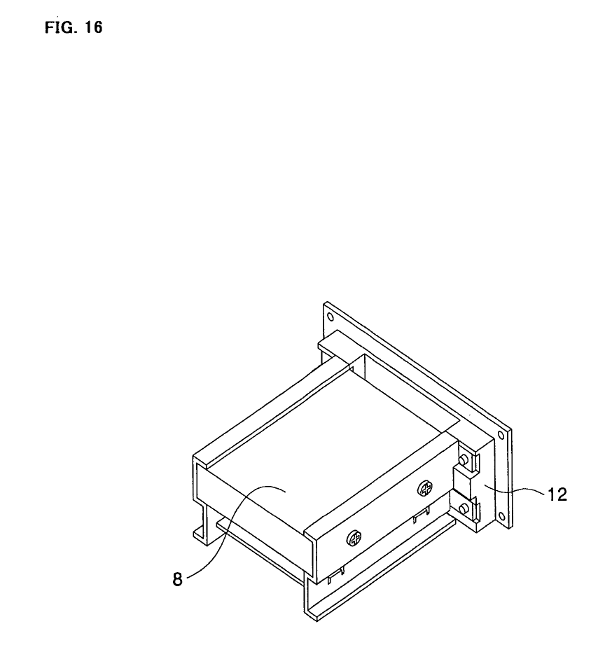

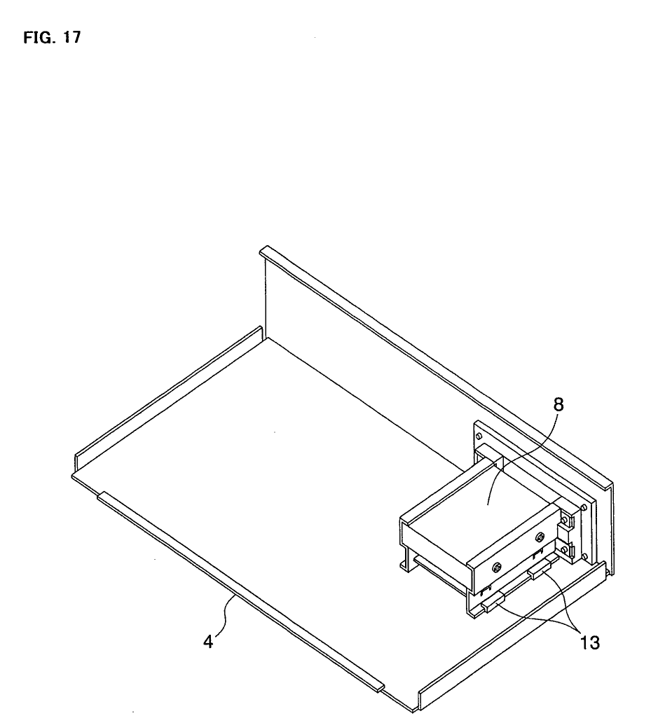

FIG. 15 is a perspective view showing a state before mounting a rear plate 12 at the rear face side of the hard disk unit 8, and FIG. 16 is a perspective view showing a state after mounting the rear plate 12 at the rear face side of the hard disk unit 8. When the rear plate 12 is mounted on the rear face side of the hard disk unit 8, a member having a shield effect and/or a sound proof effect is mounted together with the rear plate 12 or the rear plate 12 itself is formed of a member having the shield effect and/or the sound proof effect, whereby the rear plate may be mounted on the hard disk unit 8. FIG. 17 is a perspective view showing a state in which the hard disk unit 8 is mounted on the chassis 4.

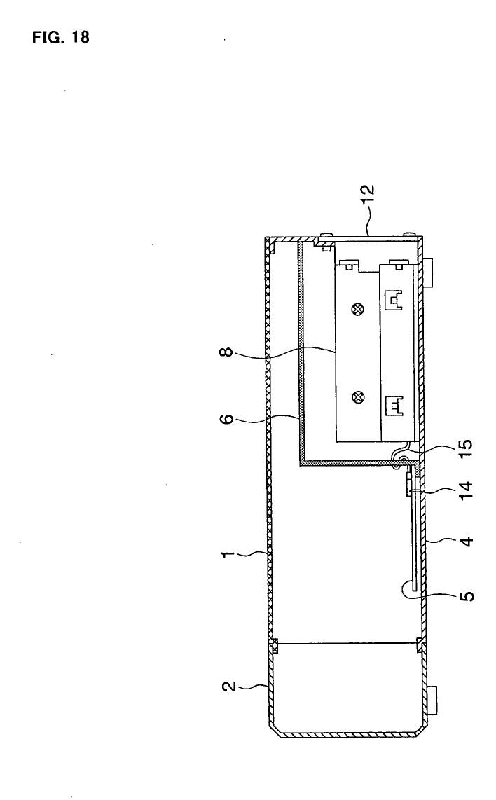

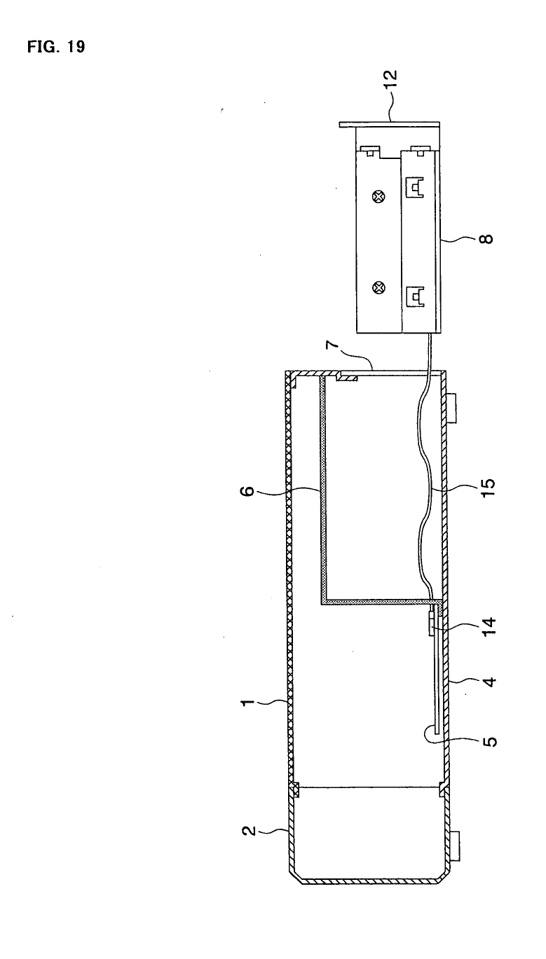

FIG. 18 is a side cross section of the electronic device showing a state in which the hard disk unit 8 is mounted in the electronic device. In the figure, a connector terminal 14 provided on a main board 5 for controlling the electronic device disposed inside of the electronic device, and a connector terminal (not shown) provided on the control board 11 of the hard disk unit 8, are connected to each other via a cable 15. The hard disk unit 8 is mounted from the outside of the electronic device so that the connector terminal 14 provided on the main board 5 in the electronic device and the connector terminal (not shown) provided on the control board 11 of the hard disk unit 8 are proximal to each other. In addition, in the case where hard disk control is included in the main board 5, a connector terminal (not shown) provided in the hard disk drive 10 and the connector terminal 14 provided on the main board 5 are disposed to be proximal to each other, and the connector terminal (not shown) provided in the hard disk drive 10 and the connector terminal 14 provided on the main board 5 are connected to each other via the cable 15. While the present embodiment has described a case in which the connector terminal 14 provided on the main board 5 in the electronic device and the connector terminal (not shown) at the side of the hard disk drive 10 are connected to each other via the cable 15, means for directly connecting two connector terminals opposed to each other, for example, may be used without being limited thereto. FIG. 19 is a side cross section of the electronic device showing a state in which the hard disk unit 8 has been removed from the electronic device.

Now, an internal structure of the electronic device in the present embodiment will be described here. As shown in FIG. 13, the shield member 6 is mounted so as to cover the front face side of the opening portion 7 formed on the chassis 4. An inside space of the shield member 6 and an outside space of the shield member 6 are formed in a housing, and the inside space of the shield member 6 is defined as a housing space of the hard disk unit 8. The opening portion 7 formed at the rear face side of the chassis 4 is formed in dimensions such that the hard disk unit 8 can be mounted on or removed from the inside of the housing. In addition, the outside space of the shield member 6 is provided as a space for arranging constituent elements of the electronic device excluding the hard disk unit 8, and the main board 5 is also one of the constituent elements.

On the other hand, as shown in FIGS. 15 and 16, the rear plate 12 is assembled at the rear face side of the hard disk unit 8, and the hard disk unit 8 including the rear plate 12 is assembled from the rear face side of the electronic device into an inside space of the electronic device through the opening portion 7 of the chassis 4, whereby the rear plate 12 functions as a cover member which covers the opening portion 7 formed on the chassis 4 of the electronic device. Fixing means used when the rear plate 12 is assembled at the rear face side of the chassis 4 is not limited in particular, and a variety of removable fixing means such as screw tightening or a hook having a claw section can be used.

Now, a description will be given with respect to specific procedures when a user replaces the hard disk drive 10 assembled in the inside of the electronic device. First, as shown in FIG. 18, at the rear face side of the electronic device in a state in which the hard disk unit 8 has been mounted in the device, fixing means such as a screw or a hook for assembling the rear plate 12 with the chassis 4 is removed, assembling between the rear plate 12 and the chassis 4 is released, and the rear plate 12 is removed from the electronic device, whereby, as shown in FIG. 19, the rear plate 12 and the hard disk unit 8 can be removed from the opening portion 7 to the outside of the housing of the electronic device in their integrated state. At this time, a work of removing the mounted hard disk unit 8 is carried out from the rear face side of the electronic device. Thus, unlike the first embodiment, there is no need for inverting the top face side and the bottom face side to place the bottom face side of the electronic device to be its top face side, and it is possible to remove the hard disk unit 8 to the outside of the housing of the electronic device while the electronic device is installed in a normal use state. A tightening tool such as a screw is removed from the hard disk unit 8 removed from the housing of the electronic device, and the current hard disk drive is replaced with a new hard disk drive 10. In the case where the new hard disk drive 10 after replaced is mounted on the electronic device, this mounting can be easily achieved by reversing the above procedures. In addition, when the hard disk drive 10 is removed from the hard disk unit 8, the support members 9 and the control board 11 assembled with the hard disk drive 10 are fully removed, whereby the support members 9 and the control board 11 may be assembled again with the new hard disk drive 10 to replace. However, in the case of the present embodiment, a construction in which the hard disk drive 10 and the control board 11 are assembled with the support members 9 is provided, thus making it possible to remove a tightening tool for tightening the hard disk drive 10 and the support members 9 and remove and replace only the hard disk drive 10 from the hard disk unit 8. Further, it is possible to remove and replace only the hard disk drive 10 in a state in which the rear plate 12 is assembled with the hard disk unit 8.

As has been described above, according to an electronic device including a recording and reproducing unit in the present invention, a mounting and removing operation of the hard disk drive 10 which is a type of a recording and reproducing unit on or from the electronic device becomes very easy as compared with a conventional technique. In addition, in the housing of the electronic device, there is provided a structure of separately providing an inside space of the shield member 6 and/or a sound proof member for storing the hard disk unit 8 and an outside space of the shield member 6 and/or the sound proof member for arranging constituent elements of the electronic device excluding the hard disk unit 8. Thus, with respect to shutdown of noise generated at the time of driving the hard disk drive 10, remarkable effect can be attained as compared with a conventional technique.

In addition, according to the present invention, the shield member 6 and/or the sound proof member are integrally formed so as to cover the periphery of the hard disk unit 8, making it possible to mount the shield member 6 and/or the sound proof member in the unit in advance at a stage of manufacturing an electronic device. Thus, there can be provided a highly sealed space capable of reliably covering the hard disk unit 8 which includes the hard disk drive 10 in a small internal space without any consideration of the shape or process of the shield member 6 and/or the sound proof member in which mounting and removal of the hard disk drive 10 have been presumed.

Further, in the present embodiments, the first embodiment has described a structure capable of mounting and removing the hard disk unit 8 which includes the hard disk drive 10 on or from the opening portion 7 formed on the bottom face side of the chassis 4 of the electronic device. The second embodiment has described a structure capable of mounting or removing the hard disk unit 8 which includes the hard disk drive 10 on or from the opening portion 7 formed on the rear face side of the chassis 4 of the electronic device. The present invention is not limited to these embodiments. Various modifications can occur without departing from the spirit of the invention. For example, there may be provided a structure of mounting a cover member on the hard disk unit 8, wherein a continuous opening portion 7 associated with two faces is formed at a corner portion at which the bottom face side and the rear face side of the chassis 4 bearing a bottom face and a rear face of the electronic device are orthogonal to each other; and there are integrally formed a bottom plate 3 for covering the opening portion 7 provided at the bottom face side of the chassis 4 and a rear plate 12 for covering the opening portion 7 provided at the rear face side of the chassis 4.

While the hard disk drive 10 is exemplified as a recording and reproducing unit for explaining the embodiments of the present invention, the recording and reproducing unit in the present invention is not limited thereto. The present invention can be easily applied as a structure of mounting or removing a disk recording or reproducing unit for carrying out recording/reproduction on a disk shaped storage medium or a unit for carrying out recording/reproduction on a card shaped storage medium.

In addition, the electronic device according to the present invention can also be applied to a composite electronic device including a plurality of recording and reproducing units as well as an electronic device including a single recording and reproducing unit.

1. An electronic device comprising, in a housing:
a recording and reproducing unit; and
a control board which controls the recording and reproducing unit, wherein a structure capable of removably mounting the recording and reproducing unit from a bottom face side of the housing is provided.

2. An electronic device comprising, in a housing:
a recording and reproducing unit; and
a control board which controls the recording and reproducing unit, wherein a structure capable of removably mounting the recording and reproducing unit from a rear face side of the housing is provided.

3. The electronic device comprising the recording and reproducing unit according to claim 1, wherein an opening portion of a size according to external dimensions in a direction in which the recording and reproducing unit is removably mounted is formed on a housing face in a direction in which the recording and reproducing unit of the housing can be removably mounted.

4. The electronic device comprising the recording and reproducing unit, wherein the opening portion according to claim 3 is continuously formed on a bottom face side and a rear face side of a housing.

5. The electronic device comprising the recording and reproducing unit according to claims 1, further comprising a cover member having a size for covering the opening portion, wherein the recording and reproducing unit is mounted on the cover member, and the recording and reproducing unit is configured to be mountable and removable from the housing together with the cover member.

6. The electronic device comprising the recording and reproducing unit according to claim 5, wherein the cover member is either one of a cover member having a size for covering the opening portion formed on the bottom face of the housing, a cover member having a size for covering the opening portion formed on the rear face of the housing, and a cover member having a size for covering the opening portion continuously formed on the bottom face and the rear face of the housing.

7. The electronic device comprising the recording and reproducing unit according to claim 6, wherein the cover member having the size for covering the opening portion continuously formed on the bottom face and the rear face of the housing is integrally formed.

8. The electronic device comprising the recording and reproducing unit according to claim 6, wherein the cover member having the size for covering the opening portion continuously formed on the bottom face and the rear face of the housing has different members between a member covering a bottom face portion and a member covering a rear face portion.

9. An electronic device comprising, in a housing: a recording and reproducing unit; and
a control board which controls the recording and
reproducing unit, wherein the recording and reproducing unit is constituted to be mountable and removable from a bottom face side or a rear face side of the housing and comprises a sound proof member or a shield member for covering the opening portion.

10. The electronic device comprising the recording and reproducing unit according to claim 1, wherein a main board which controls the electronic device is disposed in a housing of the electronic device; and wherein a connector terminal provided on the main board and a connector terminal provided on the recording and reproducing unit or a control board which controls the recording and reproducing unit are disposed proximal to each other in the housing.

11. The electronic device comprising the recording and reproducing unit according to claim 10, wherein the connector terminal provided on the main board and the connector terminal provided on the recording and reproducing unit or the control board which controls the recording and reproducing unit are linked with each other via a wire rod.

12. The electronic device comprising the recording and reproducing unit according to claim 1, wherein the recording and reproducing unit is a hard disk drive configured by assembling a recording medium in the unit in advance.

13. The electronic device comprising the recording and reproducing unit according to claim 2, wherein an opening portion of a size according to external dimensions in a direction in which the recording and reproducing unit is removably mounted is formed on a housing face in a direction in which the recording and reproducing unit of the housing can be removably mounted.

14. The electronic device comprising the recording and reproducing unit, wherein the opening portion according to claim 13 is continuously formed on a bottom face side and a rear face side of a housing.

15. The electronic device comprising the recording and reproducing unit according to claim 2, further comprising a cover member having a size for covering the opening portion, wherein the recording and reproducing unit is mounted on the cover member, and the recording and reproducing unit is configured to be mountable and removable from the housing together with the cover member.

16. The electronic device comprising the recording and reproducing unit according to claim 15, wherein the cover member is either one of a cover member having a size for covering the opening portion formed on the bottom face of the housing, a cover member having a size for covering the opening portion formed on the rear face of the housing, and a cover member having a size for covering the opening portion continuously formed on the bottom face and the rear face of the housing.

17. The electronic device comprising the recording and reproducing unit according to claim 16, wherein the cover member having the size for covering the opening portion continuously formed on the bottom face and the rear face of the housing is integrally formed.

18. The electronic device comprising the recording and reproducing unit according to claim 16, wherein the cover member having the size for covering the opening portion continuously formed on the bottom face and the rear face of the housing has different members between a member covering a bottom face portion and a member covering a rear face portion.

19. The electronic device comprising the recording and reproducing unit according to claim 2, wherein a main board which controls the electronic device is disposed in a housing of the electronic device; and wherein a connector terminal provided on the main board and a connector terminal provided on the recording and reproducing unit or a control board which controls the recording and reproducing unit are disposed proximal to each other in the housing.

20. The electronic device comprising the recording and reproducing unit according to claim 9, wherein a main board which controls the electronic device is disposed in a housing of the electronic device; and wherein a connector terminal provided on the main board and a connector terminal provided on the recording and reproducing unit or a control board which controls the recording and reproducing unit are disposed proximal to each other in the housing.

21. The electronic device comprising the recording and reproducing unit according to claim 19, wherein the connector terminal provided on the main board and the connector terminal provided on the recording and reproducing unit or the control board which controls the recording and reproducing unit are linked with each other via a wire rod.

22. The electronic device comprising the recording and reproducing unit according to claim 20, wherein the connector terminal provided on the main board and the connector terminal provided on the recording and reproducing unit or the control board which controls the recording and reproducing unit are linked with each other via a wire rod.

23. The electronic device comprising the recording and reproducing unit according to claim 2, wherein the recording and reproducing unit is a hard disk drive configured by assembling a recording medium in the unit in advance.

24. The electronic device comprising the recording and reproducing unit according to claim 9, wherein the recording and reproducing unit is a hard disk drive configured by assembling a recording medium in the unit in advance.
